(19) United States
(12) Patent Application Publication
(10) Pub. No.: US 2025/0135726 A1
(43) Pub. Date: May 1, 2025

(54) INDIRECT ADDITIVE MANUFACTURING INSTALLATION AND METHOD

(71) Applicants: ECOLE NATIONALE SUPERIEURE DES MINES DE PARIS, PARIS (FR); ASSOCIATION POUR LA RECHERCHE ET LE DEVELOPPEMENT DES METHODES ET PROCESSUS INDUSTRIELS "ARMINES", PARIS (FR); J.P.B SYSTEME, MONTEREAU-SUR-LE-JARD (FR)

(72) Inventors: Benjamin SANGOUARD, PARIS (FR); Christophe COLIN, EVRY (FR); Emmanuel DIOH, MELUN (FR); Brieuc BADIN, THOMERY (FR)

(21) Appl. No.: 18/928,477

(22) Filed: Oct. 28, 2024

(30) Foreign Application Priority Data
Oct. 30, 2023 (FR) 2311801

(51) Int. Cl. B29C 64/393; B29C 64/165; B33Y 10/00; B33Y 30/00; B33Y 50/02

(52) U.S. Cl. CPC B29C 64/393; B29C 64/165; B33Y 10/00; B33Y 30/00; B33Y 50/02

(57) ABSTRACT

Indirect additive manufacturing installation for indirect additive manufacturing by projection of binder onto a powder bed, comprising a support, a powder supply means configured to form successive powder beds on the support, a print head configured to selectively project the binder onto each of the successive powder beds, and a counting device for counting the drops of binder projected by the print head onto the powder beds. A method for indirect additive manufacturing by projecting binder onto a powder bed, comprising forming successive powder beds on a support, selectively projecting binder onto each of the powder beds, the method further comprising counting the projected binder drops.

### TECHNICAL FIELD

This disclosure relates to the field of additive manufacturing, and more particularly to an installation and a method for indirect additive manufacturing by projecting binder onto a powder bed. Such an installation and such a method can be used, in particular but not exclusively, for the additive manufacturing of aeronautical and aerospace parts.

### BACKGROUND

Additive manufacturing is a set of techniques that allow a part to be manufactured not by removing material, but by successive additions of material until the desired shape of the part is created. These techniques have many advantages, including the ability to manufacture parts that could not be manufactured by other processes.

There are various additive manufacturing processes, such as laser powder bed fusion (LPBF), most of which have relatively low productivity in common. Recently, indirect additive manufacturing by binder projection onto a powder bed (optionally on metal powder, in which case this is called MBJ-“Metal Binder Jetting”) has been developed, which has a higher productivity than LPBF.

In indirect additive manufacturing by binder projection onto a powder bed, a powder bed is formed on a support, then a binder is projected onto a surface of this powder bed corresponding to a cross-section of the part to be manufactured. This binder dries at least partially, then a new powder bed is deposited on the previous powder bed, and so on until the entire part to be manufactured is reconstituted. Then, the binder is crosslinked into a solid polymer in order to provide the part, which is then called a “green” part, with sufficient mechanical strength to withstand depowdering, an operation aiming at removing excess powder from the part not bound by the polymer. After depowdering, the green part is debinded (the polymer is removed therefrom) then sintered, which allows to obtain the final part.

Printing the binder into the powder bed, curing the binder into a polymer, and sintering into a dense part induce changes in the dimensions and shape of the part during its manufacture. These changes make it more difficult to comply with the geometry of the final part as specified.

The present disclosure aims at least partially at overcoming these disadvantages.

### SUMMARY

For this purpose, the present disclosure relates to an indirect additive manufacturing installation for indirect additive manufacturing by projection of binder onto a powder bed, comprising a support, a powder supply means configured to form successive powder beds on the support, a print head configured to selectively project the binder onto each of the successive powder beds, and a counting device for counting the drops of binder projected by the print head onto the powder beds.

The indirect additive manufacturing installation, hereinafter simply called installation, may comprise one or more machines. The support, which may be in the shape of a manufacturing tray, is capable of supporting a first powder bed, the following powder beds then being deposited on top of each other.

The powder supply means allows to form successive powder beds on the support. The supply means may therefore comprise one or more systems, in particular for ensuring the distribution of the powder on the support (or on the previous bed), spreading this powder in layers called beds, and/or compacting the powder bed.

If necessary, the installation may comprise a drying means configured to partially or completely dry the binder. Moreover, the installation may comprise a means for crosslinking the binder, which may be provided on the same machine as the support or on another machine of the installation.

The print head may comprise one or more nozzles. Each nozzle may be configured to project binder drop by drop. Thus, hereinafter and unless otherwise stated, the terms “project” and “print” are synonymous.

The binder drop counting device allows to assess whether a drop has actually and effectively been projected by the print head onto the powder bed.

Thanks to the drop counting device, beyond the theoretical surface on which the print head is supposed to project binder, it is possible to estimate more precisely the surface actually printed on each powder bed, in particular at the edge of the surface to be printed, therefore the dimensions of the printed part. It is also possible to measure the dimensions of the part after crosslinking the binder and after sintering. This data therefore allows to determine the geometric (potentially anisotropic) transformation of the part that occurs during crosslinking and sintering, and therefore to be able to predict the dimensions to be printed based on the desired dimensions for the final part, independently of the information provided by the manufacturer of a particular installation, for particular materials and for particular configurations of the installation. This results in better control of additive manufacturing by projecting binder onto a powder bed, but also increased productivity. In addition, better knowledge of the saturation of the powder beds with binder, potentially at the scale of each layer, thanks to the number of drops projected, allows to optimize the desired compromise between printing time and the quality of the manufactured part. From this point of view also, the productivity of the method is increased.

In some embodiments, the counting device is configured to determine the positioning of the binder drops projected by the print head onto the powder beds. The positioning of a drop designates the position, on a powder bed, at which this drop was printed. The positioning of the drops can therefore be identified relative to the support, directly or indirectly, for example via the print head, the position of the print head relative to the support being otherwise known. Taking into account the actual positioning of the projected binder drops allows to approach the local saturation of the powder bed with binder more precisely.

In some embodiments, the counting device is configured to take as input an activation signal of the print head. In these embodiments, the print head is configured to project at least one drop of binder under the effect of an activation signal.

By knowing the quantity of drops projected by the print head at each activation, the counting device can, from the number of activations determined on the basis of the activation signal received as input, estimate the number of drops projected in total on each powder bed. Although this estimate may not correspond exactly to the number of drops actually projected, typically when a nozzle is clogged, it is generally still good enough to obtain the aforementioned advantages.

In some embodiments, the counting device comprises an optical means configured to optically detect the passage of drops between the print head and the powder bed. The optical means detects the actual passage of drops between the print head and the powder bed; in this way, it provides a very precise measurement of the number of drops actually deposited, regardless of whether the print head responded correctly or not to the activation signal or whether the nozzle is clogged. Moreover, depending on the means used and its positioning relative to the trajectory of the drops, the optical means may be able to provide the position of the drops that have passed or not, which allows to identify defective nozzles (which are for example clogged) on the print head. The optical means may be fixed relative to the print head. Moreover, knowing the position of the print head relative to the position of the support, it is possible to derive the positions at which the drops were actually printed.

An optical means is a means using an electromagnetic wave, in particular a plane wave; the wavelengths that can be used are not limited to the visible range, but can also cover infrared, ultraviolet, etc. Depending on the optical means used, the binder may comprise a dye or any other additive in order to improve its detectability by the optical means. Conversely, the wavelength used may be selected according to the binder chosen.

The optical means may be configured to detect the actual passage of drops at any point on the surface to be printed, for example thanks to a disturbance of an optical signal emitted and received by the optical means when a drop passes.

In some embodiments, the counting device is configured to correct a count made from a print head activation signal based on the optical detection of the drop passage.

In some embodiments, the counting device is configured to emit a clogging signal, optionally of a given nozzle, when the number of drops actually projected is less than the number of drops that should be projected based on the activation signal, and/or when the activation signal predicts the projection of a drop by a given nozzle but the nozzle does not project any drops.

In some embodiments, the optical means comprises at least one of a laser sheet, a scanner and a set of diodes. In principle, these means operate by emitting an optical beam on the path of the drops, and by detecting the disturbance of this beam when a drop passes. Measuring the disturbance can allow to trace the position of the projected drop.

In particular, the optical means may comprise a plurality of sensors, the sensors are arranged such that a disturbance caused by the projection of a given drop is detected by only one sensor. For example, the sensors may be isolated from one another, in particular optically. For example, the optical sensors may be arranged next to one another, typically in a row, such that their field of action comprises one and only one nozzle. Thus, there is no overlap between the different sensors. Each of the sensors may comprise a receiver associated with an optical emitter, for example a laser emitter, placed opposite the receiver in order to detect a drop when the optical beam is interrupted.

The counting device may have a sufficient detection frequency, for example greater than 5 kHz, preferably greater than 20 kHz, to ensure counting the drop despite the projection of the drop at high speed.

In some embodiments, the indirect additive manufacturing installation further comprises a nozzle cleaner configured to clean at least one nozzle of the print head based on a clogging signal emitted by the counting device. The clogging signal can be emitted as detailed above. Cleaning the nozzles when necessary, in addition to possible periodic cleaning, allows to ensure good reproducibility of the manufacturing from one part to another, therefore good manufacturing quality. The nozzle cleaner may clean the nozzles by physical processes (for example with a scraper, typically of the windshield wiper type) and/or chemical processes (for example with a cleaning product, for example a solvent of the binder).

In some embodiments, the indirect additive manufacturing installation comprises a unit for evaluating the dimensions of a part printed by binder projection based on the number of drops counted or, where appropriate, the number of drops whose passage is detected.

The evaluation unit may also take into account at least one of the following quantities: the number of drops printed on each layer, the spread of the drops (for example in the form of a spreading coefficient, in particular its maximum value), the distance(s) separating two adjacent drops in the two directions X and Y of the surface of the powder bed, the overflow of the peripheral drops relative to the contour of the theoretical surface to be printed (which may be defined by a Computer Aided Design-CAD) file, the thickness of a powder bed, the number of powder beds, the porosity of the powder bed, the type of powder, the type of binder, the ratio between the powder mass of the crosslinked part and the powder mass of the theoretical part (defined by CAD).

More generally, the printed surface depends on the number of drops printed and on a drop spreading factor, related to the saturation chosen by the operator, which itself depends on the spacing between two consecutive drops in each direction of the plane of a layer.

Moreover, as previously explained, the evaluation unit may also calculate the transformation between the CAD-defined part and the crosslinked part, then between the crosslinked part and the sintered part, which therefore allows to improve the dimensional control of the part compared to the final specifications.

In some embodiments, the indirect additive manufacturing installation comprises a unit for calculating the binder saturation of the powder bed based on the number of drops counted (or, where appropriate, the number of drops whose passage is detected), and optionally a drop spreading coefficient.

At the powder bed scale, saturation, sometimes called “true” saturation, is the ratio between the volume of binder projected onto the surface to be printed of the powder bed and the volume of pores of the volume infiltrated by the binder of this same powder bed. In other words, “true” saturation is the volume of binder projected divided by the volume of pores that is partially or totally occupied by the binder (that is to say excluding the non-infiltrated area of the powder bed, onto which, by definition, no binder is projected). For example, excluding the possible evaporation of the binder solvents, if the binder completely fills the pores of the infiltrated volume of the powder bed, “true” saturation is 100% and the infiltrated volume is said to be saturated. If, on the other hand, the infiltrated volume has pores not entirely filled by binder, “true” saturation is less than 100% and the infiltrated volume is said to be unsaturated.

The “true” saturation can be approximated by a so-called “corrected” saturation, equal to the number of drops deposited multiplied by the volume of a drop, all divided by the product of the porosity of the powder bed and the infiltrated volume of the powder bed, the infiltrated depth of which may or may not exceed the thickness of the powder bed. Manufacturers of indirect additive manufacturing installations sometimes define an estimated saturation that differs from the true saturation and the corrected saturation because it is based in particular on the assumption that the binder projected for a layer is necessarily distributed over and only over the entire depth of this layer. Thus, the saturation estimated by the manufacturer may be greater than 100% to the extent that the layer thickness is less than the infiltrated depth or less than 100%, in the case where the layer thickness is greater than the infiltrated depth. The infiltrated depth can be estimated on the basis of preliminary tests.

The “true” saturation governs the mechanical strength of the crosslinked part, which is why knowing it more precisely, as approached using the corrected saturation and the number of drops counted (or even detected), allows for better control of the mechanical properties of the crosslinked part, particularly for resistance to depowdering, regardless of the saturation given by the machine.

The present disclosure also relates to an indirect additive manufacturing method by projecting binder onto a powder bed, comprising the formation of successive powder beds on a support, the selective projection of binder onto each of the powder beds, the method further comprising counting the projected binder drops. The method may be implemented by an installation as described above.

In particular, forming powder beds may comprise the deposition of powder (that is to say, the fact of depositing powder), the spreading into beds, and the compaction of each powder bed.

The method may comprise partially or completely drying the binder solvent(s). The method may comprise crosslinking the binder.

The selective projection of binder can be carried out by a print head.

In some embodiments, the method comprises adjusting the print head according to a binder saturation of the powder bed calculated based on the number of drops counted or, if applicable, based on the number of drops whose passage is detected. This saturation may correspond to the corrected saturation mentioned above. The adjustment can involve the number of print head passes, the print head pass speed, the volume of the drops, and the nozzle activation frequency. The amount of binder to be deposited by the print head also depends on the layer thickness selected for that print. At equal saturation but different layer thicknesses, the print head adjustment parameters can be selected to deposit more binder per layer in a relatively thick layer than in a relatively thin layer. Because the print head is adjusted according to the corrected saturation that better approximates the “true” saturation than the saturation estimated by the machine manufacturer, the indirect additive manufacturing method is better controlled, as are the mechanical properties of the crosslinked part.

### BRIEF DESCRIPTION OF THE DRAWINGS

Other features and advantages of the object of the present disclosure will emerge from the following description of embodiments, given as non-limiting examples, with reference to the appended figures.

FIG. 1 schematically illustrates the steps of an indirect additive manufacturing method by projecting binder onto a powder bed according to an embodiment.

FIG. 2 is a diagram, in top view, of an indirect additive manufacturing installation for indirect additive manufacturing by projection of binder onto a powder bed according to an embodiment.

FIG. 3 is a block diagram illustrating the architecture of a drop counting device according to an embodiment.

FIG. 4 is a diagram, in top view, of an indirect additive manufacturing installation for indirect additive manufacturing by projection of binder onto a powder bed according to an embodiment, during printing.

FIG. 5 illustrates, in top view, a four-drop model for determining the coverage rate and spreading coefficient.

### DETAILED DESCRIPTION

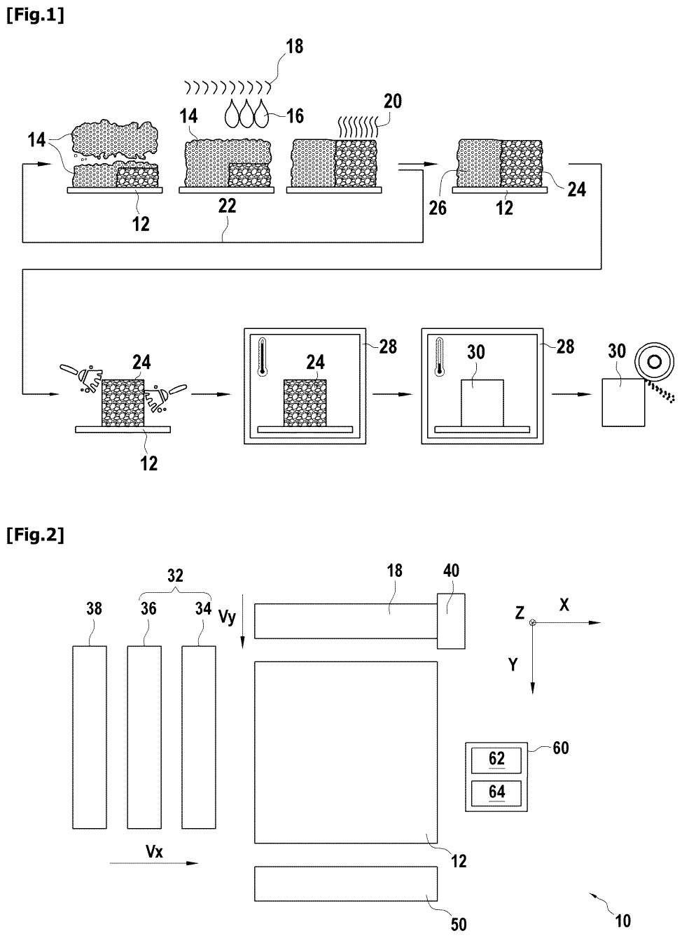

The principle of an indirect additive manufacturing method by projecting binder onto a powder bed is illustrated in FIG. 1. The method comprises the formation of successive powder beds 14 on a support 12. Each powder bed 14 is formed on the previous powder bed, except the first powder bed which may be in direct contact with the support 12.

The powder may be a metal powder, for example an Iron-Nickel alloy such as IN718 (Inconel, registered trademark, whose composition is detailed in Table 1, excluding unavoidable impurities). However, other materials may be considered, such as stainless steel such as SS316L steel (whose composition is detailed in Table 2, excluding unavoidable impurities).

TABLE 1

| Elements | C | Mn | P | S | Si | Cr | Ni | Mo |
|---|---|---|---|---|---|---|---|---|
| Min | 0.02 | — | — | — | — | 17 | 50 | 2.8 |
| (mass %) | | | | | | | | |
| Max | 0.08 | 0.35 | 0.015 | 0.015 | 0.35 | 21 | 55 | 3.3 |
| (mass %) | | | | | | | | |
| Elements | B | Ti | Ta | Nb | Cu | Co | Al | Fe |
| Min | — | 0.6 | — | 4.75 | — | — | 0.2 | — |
| (mass %) | | | | | | | | |
| Max | 0.006 | 1.2 | 0.05 | 5.50 | 0.3 | 1 | 0.8 | Complement |
| (mass %) | | | | | | | | |

TABLE 2

| Elements | C | Mn | P | S | Si | Cr | Ni | Mo |
|---|---|---|---|---|---|---|---|---|
| Min | — | — | — | — | — | 16 | 9 | 1.5 |
| (mass %) | | | | | | | | |
| Max | <0.03 | <2 | <0.01 | <0.005 | 1 | 19 | 13 | 3 |
| (mass %) | | | | | | | | |

| Elements | N | O | Fe |
|---|---|---|---|
| Min | — | — | — |
| (mass %) | | | |
| Max | <0.003 | <0.002 | Complement |
| (mass %) | | | |

The method also comprises the selective projection of binder onto each of the powder beds 14. Thus, after formation of a powder bed, a binder 16 is projected onto this powder bed 14, before the formation of a following powder bed 14. The binder 16 may be projected by a print head 18, for example in the form of drops. The projection is said to be selective insofar as the projection of binder 16 may not be made over the entire powder bed 14, but only on a surface to be printed and which corresponds to a section of the part to be manufactured. Such a surface may be defined in a CAD file.

The binder 16 may comprise one or more solvents and one or more polymers in solution in all of these solvents. For example, the binder may be a mixture of water, ethylene glycol and 2-butoxyethanol (3 solvents) with polyvinylpyrrolidone (1 polymer).

The binder 16 infiltrates into the powder bed 14 and may then undergo natural or forced drying 20, during which the binder, and in particular its solvents, partially evaporates. For example, the drying temperature may be comprised between 25° C. and 70° C. It is possible to observe a pause time, for example of the order of several seconds, between the infiltration of the binder 16 and the start of drying.

As schematically shown by the arrow 22, these steps may be repeated, a new powder bed 14 being deposited on the powder bed which has previously received binder, until the shape of the part to be manufactured, thus built up layer by layer, is entirely printed.

After printing the part layer by layer, a crosslinking step allows the binder to be crosslinked, for example to be polymerized. This results in a generally single-piece green part 24, the rest of the powder 26 remaining in the granular state. For example, crosslinking may be carried out at a temperature of 200° C. for 12 hours, in air. After crosslinking, the green part 24 must have a sufficiently high breaking strength to withstand the subsequent steps. For example, to withstand the handling required for depowdering, it is preferable for the green part 24 to have an equivalent four-point bending breaking stress (standard test) greater than or equal to 5, 6 or 7 MPa, or even 20, 21 or 22 MPa for worked parts, otherwise the green part 24 is very likely to deteriorate during depowdering. The term “equivalent breaking stress” is used because the stress calculation formula for this test applies to dense materials, which is not the case for green parts.

Printing followed by crosslinking of the binder 16 can induce a change in the volume of the green part 24 compared to the dimensions of the part defined by the CAD file. Most often, this is an increase in volume whose origin is a gain in powder mass compared to that of the CAD part, caused by an overflow of the drops outside the contours of the part.

The green part 24 then undergoes depowdering, which may be carried out in a manner known per se, consisting of removing the unprinted powder residues 26 from the green part 24. For example, the depowdering may be carried out using a compressed air nozzle (typically with a maximum pressure of 2 bar). Then, the green part 24 is debinded and sintered. As illustrated in FIG. 1, the debinding may be carried out by placing the green part 24 in an oven 28. The debinding may comprise a heat treatment of the green part 24 at a temperature higher than the crosslinking. For example, the debinding may comprise maintaining the green part at approximately 350° C. for 10 to 15 hours. The atmosphere in the furnace 28 may be an inert atmosphere, for example argon, optionally supplemented with dihydrogen (for example up to 5% by volume) or a dry oxidizing atmosphere, for example synthetic air requiring a thermal cycle adapted to this type of atmosphere. More generally, the temperature in the furnace 28 must be higher than a lower limit ensuring the total disappearance of the binder (or more precisely of the polymer) and lower than an upper limit which does not generate significant oxidation of the part.

After debinding, the part called brown part can be sintered, in the same furnace 28 or a different furnace. For example, sintering may be carried out at a temperature below the solidus, for example of the order of 1220° C. for Inconel 718 (registered trademark) whose solidus is 1250° C. The atmosphere in the furnace 28 may be a secondary vacuum (pressure below 10-5 mbar) or argon with 5% by volume of dihydrogen or pure dihydrogen. Oxygen traps (getters) can be present in the furnace 28, for example a titanium-based alloy such as TA6V.

Sintering allows densification of the brown part to obtain the final part 30. Due to this densification, it is possible to again observe a variation in volume and therefore a change in dimension of the part 30 compared to the green part 24, and a fortiori compared to the printed part and the part defined by the CAD file.

The final part 30 can then cool, for example in the oven 28 or outside. If necessary, the final part 30 may finally be finished, as shown in the last step of FIG. 1.

FIG. 2 illustrates more particularly, in top view, an installation 10 for indirect additive manufacturing by projecting binder onto a powder bed. The installation 10 comprises a support 12 on which successive powder beds 14 can be formed. The support 12 may comprise a manufacturing plate. The support 12 may extend generally in a plane XY. Furthermore, the support 12 may slide in a direction Z normal to the powder beds 14, therefore here to the support 12; for example, the support 12 may lower after each printing, in order to accommodate a new powder bed 14. The directions X, Y and Z may form an orthogonal reference frame.

To form the powder beds 14, the installation 10 comprises a powder supply means 32. In this case, the powder supply means 32 may comprise a spreading means 34 and a depositing means 36. The depositing means 36, for example a hopper, is configured to deposit powder on the support 12, and the spreading means 34, for example a roller or a scraper, is configured to spread the deposited powder and compact it, in order to have a powder bed 14 that is as homogeneous as possible in density and having a desired compactness. The hopper may be a vibrating hopper. The roller may be counter-rotating, that is to say, it may be rotated on itself in the direction opposite to its translation relative to the layering of the powder bed 14.

Moreover, the installation 10 may comprise a drying means 38, for example an infrared lamp, configured to dry the binder 16 printed on the powder bed 14. The drying means 38, or another means, may be configured to maintain the powder bed at a temperature above ambient temperature, for example between 30° C. and 60° C., preferably between 35° and 45° C.

In the present embodiment, the spreading means 34, the depositing means 36 and the drying means 38 may move relative to the support 12 in the direction X, at a speed Vx which may vary depending on the means considered.

The installation 10 further comprises a print head 18 configured to selectively project binder 16 onto each of the successive powder beds 14, as previously described. For this purpose, the print head 18 here comprises a plurality of nozzles, each nozzle being capable of being controlled by an activation signal and of forming and projecting a drop of binder 16 upon instruction from the activation signal.

For example, the nozzles of the print head 18 may be of the drop on demand (DOD) family, and more particularly of the piezoelectric type: these nozzles have a piezoelectric component which deforms under the passage of a current and compresses the liquid, thus generating a drop of binder. Alternatively, the nozzles may be of the thermoelectric type, and in this case comprise a component which heats under the passage of a current, in order to create a vapor bubble in the binder chamber which, when it bursts, will project a drop of binder. Other types of nozzles may also be used within the framework of the installation 10.

In this embodiment, the print head 18 may move relative to the support 12 in the direction Y, at a speed Vy.

The installation 10 also comprises a counting device 40 configured to count the drops of binder 16 projected by the print head 18 onto the powder beds 14. The counting device 40 may be fixed relative to the print head 18, for example attached to the print head 18.

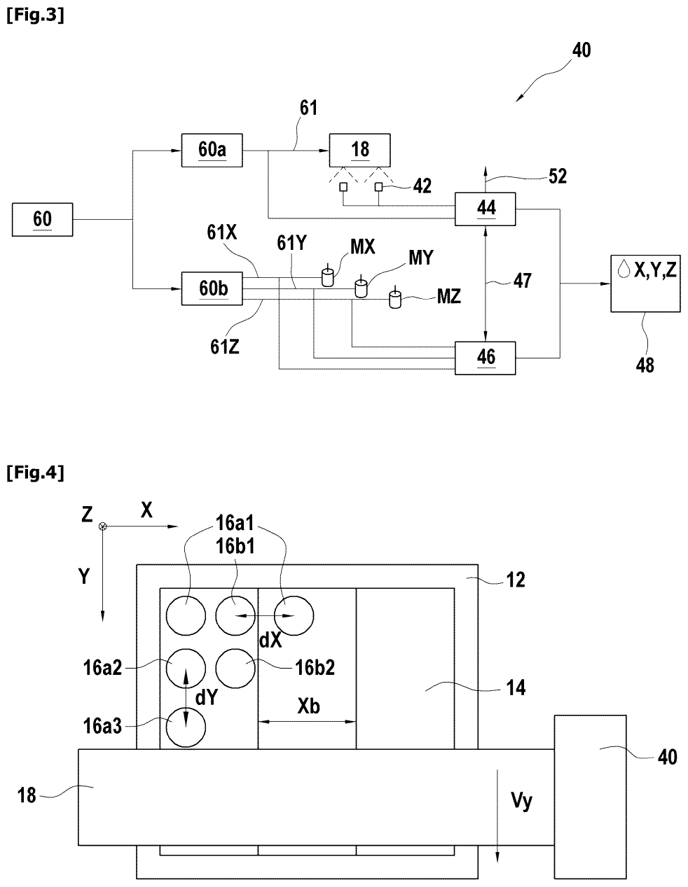

The counting device 40 is more particularly illustrated in FIG. 3. In particular, in this embodiment, the counting device 40 comprises an optical means 42 configured to optically detect the passage of drops between the print head 18 and the powder bed 14. In the example shown schematically in FIG. 3, the optical means emits one or more optical beams intersecting the path of the drops projected by the print head, and the disturbance of the beam is measured by a detector 44. A disturbance can be interpreted as the passage of a drop, while the absence of disturbance can be interpreted as the absence of passage of a drop. The wavelength of the optical means may be selected to properly detect the binder, depending on the nature and composition of the binder.

In this embodiment, the optical means 42 comprises a laser sheet, but alternatively or in addition, the optical means could comprise a scanner, or else a set of diodes.

Optionally, the counting device 40 may be configured to take as input an activation signal of the print head 18. Referring again to FIG. 2, the activation signal of the print head 18 may be emitted by a controller 60 configured to control the installation 10. The activation signal may determine the activation or not of each of the nozzles of the print head 18, depending on the position of the print head 18. More precisely, with reference to FIG. 3, the controller 60 may control an activation driver 60a of the print head 18, possibly integrated into the controller 60. The activation driver 60a is configured to send to the print head 18, and more particularly to the nozzles, an activation signal 61 which may comprise, for example, a nozzle addressing signal and a power activation signal. The addressing signal identifies the nozzles to project a drop and the power signal provides the electrical power for activating the nozzles.

The counting device 40 may, as a first approach, use the activation signal 61 to determine which nozzles have projected binder, and therefore know the theoretical number of drops of binder projected by the print head 18. For this purpose, the detector 44 may take the activation signal 61 as input.

However, thanks to the fact that the counting device 40 here comprises an optical means 42 as described above, it is possible to know not only the theoretical number of drops of binder projected but above all the number of drops of binder actually and effectively projected by the print head 18. If necessary, the counting device 40 may therefore confirm or correct a count carried out from an activation signal of the print head 18 on the basis of the optical detection of the passage of the drops through the optical means 42.

In any case, an indirect additive manufacturing method of which an example has been presented with reference to FIG. 1 may comprise a counting of the projected binder drops. This counting may be carried out by the counting device 40, for example during the projection of the drops.

The counting device 40 may be configured to determine the positioning of the binder drops projected by the print head 18 onto the powder beds 14. Determining the positioning of the drops may comprise tracking the position of the print head 18 in space and identifying, via the activation signal, the active nozzle(s). Since the nozzles are fixed relative to the print head 18, by knowing the position of the latter, it is possible to derive the position of the drop in space.

More specifically, according to an example illustrated in FIG. 3, the controller 60 may control a positioning driver 60b of the print head 18, possibly integrated into the controller 60. The positioning driver 60b is configured to position the print head 18 relative to the support, for example by sending to actuators MX, MY, MZ (here motors managing the translation of the print head in the directions X, Y, Z respectively) positioning signals 61X, 61Y, 61Z respectively. The positioning signals 61X, 61Y, 61Z may be given as input to a localization unit 46 which may, on this basis, determine the positioning of the print head 18, or even of each of the nozzles.

In order to correlate the positioning of the print head and the counting of the drops, a time synchronization 47 can be carried out between the detector 44 and the location unit 46. The detector 44 can thus return information relating to the drops emitted at each instant, while the location unit 46 can return information relating to the position of the print head 18 at each instant. By cross-referencing this information, the counting device 40 may return information 48 relating to the printing position of each drop.

Moreover, as indicated above, the optical means 42 has the role of confirming the projection of a drop. In the case of a clogged nozzle, the signal will be identified but the drop will not be projected. Thus, the combination of the position tracking of the print head 18 and the activation signal 61, or even the optical means 42, allows to determine the positioning of the binder drops projected by the print head.

Optionally, the installation 10 may comprise a nozzle cleaner 50. The cleaning of one or more nozzles of the print head 18 may be done periodically, for example every N printed layers, according to a given setting, or on demand. The nozzle cleaner 50 may comprise a scraper, for example similar to a windshield wiper, configured to scrape the dried binder at the outlet of the nozzles, and/or force into the nozzles of the print head 18 a cleaning liquid, typically comprising solvents of the binder 16, allowing to dissolve the binder that has dried inside one or more nozzles of the print head 18. This application of solvents may be carried out above a cleaning liquid recovery tank.

In particular, when the counting device 40 detects that a given nozzle receives an activation signal 61, but does not detect the passage of a drop through the optical means 42 associated with this nozzle, the counting device 40 may transmit a clogging signal 52 indicating that this nozzle is clogged. The transmission of a clogging signal 52 may cause the nozzle cleaner 50 to clean the nozzle in question, or even several nozzles, or even the entire print head 18. In the case of cleaning the entire print head 18, it is possible to wait until a certain configuration of clogged nozzles is detected to emit a clogging signal 52, for example a proportion of clogged nozzles greater than a threshold or a spatial concentration of clogged nozzles.

Besides, the controller 60 may in particular comprise a unit 62 for evaluating the dimensions of a printed part, and a unit 64 for calculating the binder saturation of the powder bed. These units will be described below. It should already be noted that in the event that the nozzles become clogged during printing, the number of drops measured by the counting device 40 (the optical means) will decrease, and therefore the volume of binder projected will decrease, as will the saturation. This allows to detect too low a saturation on the basis of a printing defect.

The operation of the print head 18 is illustrated in FIG. 4, where the print head 18 is seen moving over a powder bed 14. The print head 18 prints while moving in the direction Y. Moreover, the spacing between two adjacent nozzles of the print head 18, in the direction X, is denoted Xb. In order to project a sufficient quantity of binder, it may be necessary to perform several printing passes on the same layer, by offsetting the print head by a distance dx in the direction X. The distance dX therefore represents the spacing between the centers of two adjacent drops in the direction X.

Thus, the print head can print drops 16a1, 16a2, 16a3, etc. as it moves in the direction Y, then return to its initial position, shift by the distance dX in the direction X, then resume moving in the direction Y to print drops 16b1, 16b2, and so on. In FIG. 4, only a portion of these drops has been shown for the sake of readability.

The printing strip, of width Xb, is the printing area covered by the same nozzle, in several passes. The spacing dX of the drops along X can therefore be expressed according to the width of a printing strip and the number of passes Np of the print head 18 on the powder bed 14, according to the formula dX=Xb/Np. Moreover, the spacing dY between the centers of two adjacent drops in the direction Y varies with the speed Vy of movement of the print head 18 along Y, and the activation frequency f of the nozzles of the print head, according to the formula dY=Vy/f. If Z is also denoted as the height of the part and dZ as the height of a layer or of the powder bed along the axis Z, the number of layers (or powder beds) Nc is given by Nc=Z/dZ.

In some embodiments, the spacing dX may be greater than the median diameter d50 of the powder to achieve good infiltration of the binder. Moreover, the spacing dX may be less than the width Xb.

Moreover, the volume of a drop Vg is considered to be known because it can be measured by processes known to the person skilled in the art, for example the test called blotting paper test. This test comprises projecting a fixed number of drops onto blotting paper. The difference in mass of this blotting paper before and after the projection of the drops gives the mass of projected binder. Dividing this mass of binder by the known number of drops provides the mass of a drop of binder. Since the density of the binder is known or measured by liquid pycnometer, it is therefore possible to calculate the volume of a drop of binder.

For a given layer, N_{g,X} is the number of drops printed in the direction X and N_{g,Y} is the number of drops printed in the direction Y. The total number of drops printed in a given layer, denoted Na, is therefore equal to N_{g}=N_{g,X}. N_{g,Y} and theoretically equal to

$$\frac{{X}_{print}}{dX} \cdot \frac{{Y}_{print}}{dY} ,$$

where Xₚᵣᵢₙₜ and Yₚᵣᵢₙₜ are respectively the dimensions along X and along Y of the printed part. These dimensions Xₚᵣᵢₙₜ and Yₚᵣᵢₙₜ are not measurable but can be approximated by calculation.

As indicated above, the installation 10 comprises a unit 62 for evaluating the dimensions of the printed part. Indeed, there may be a difference in dimensions between the part to be printed defined by CAD (typically defined by an instruction file of the additive manufacturing installation) and the part actually printed. The dimensions of the part defined by CAD in the directions X, Y and Z can be denoted respectively X_{CAD}, Y_{CAD} and Z_{CAD}. At the printing step, the dimensions of the printed part in the directions X, Y and Z can be expressed as follows:
Xₚᵣᵢₙₜ=N_{g,X}. dx
Yₚᵣᵢₙₜ=N_{g,Y}. dY
Zₚᵣᵢₙₜ=Nc dZ

These dimensions are unknown and difficult to measure: their theoretical value given by the CAD file is known, but their actual value deviates from this theoretical value due to the overflow of the drops compared to the outline of the CAD file, this overflow being itself related to the spreading of the drops on the powder bed and to the possible overlapping of drops with each other. One or more drops may therefore overflow from the outline of the part called CAD part (that is to say the part as defined by the CAD file), depending on the number of passes Np of the print head 18 or the saturation in binder requested at the installation (machine saturation).

After crosslinking the binder, the dimensions of the crosslinked part in the directions X, Y and Z, denoted X_{crosslink}, Y_{crosslink} and Z_{crosslink} respectively, are measurable and can be compared with the dimensions of the CAD part. The dimensional change of the crosslinked part relative to the CAD part, in the direction X, denoted ΔX_{crosslink}^{CAD}, can be expressed as

$$\frac{Δ {X}_{crosslink}^{CAD}}{{X}_{CAD}} = \frac{{X}_{crosslink} - {X}_{CAD}}{{X}_{CAD}}$$

Identical relationships can be written for the directions Y and Z. The dimensions of the crosslinked part can be physically measured on the green part 24.

During debinding, it is assumed that no dimensional variation of the part occurs compared to the crosslinked part. The dimensions of the debinded part are difficult to be measured due to its very low mechanical strength.

However, it is possible to undertake a pre-sintering of the debinded part at an intermediate temperature lower than the densification temperature in order to generate material necks instead of polymer bridges and thus consolidate the part, which allows to measure the dimensions of the pre-sintered part in the directions X, Y and Z, noted respectively X_{necks}, Y_{necks} and Z_{necks}, slightly smaller than the dimensions of the crosslinked part, and a fortiori of the CAD part. The shrinkage of the pre-sintered part relative to the crosslinked part, in the direction X, noted ΔX_{necks}^{crosslink}, can be expressed as

$$\frac{Δ {X}_{necks}^{crosslink}}{{X}_{crosslink}} = \frac{{X}_{necks} - {X}_{crosslink}}{{X}_{crosslink}}$$

On the other hand, a clear shrinkage occurs during densification sintering (at a much higher temperature than that of pre-sintering). After sintering, the dimensions of the sintered part (which has become dense) in the directions X, Y and Z, denoted respectively Xₛᵢₙₜ, Yₛᵢₙₜ and Zₛᵢₙₜ, are smaller than the dimensions of the pre-sintered or crosslinked part, and a fortiori of the CAD part. The shrinkage of the sintered part relative to the pre-sintered part, in the direction X, denoted ΔXₛᵢₙₜ^{necks}, can be expressed as

$$\frac{Δ {X}_{sint}^{necks}}{{X}_{necks}} = \frac{{X}_{sint} - {X}_{necks}}{{X}_{necks}}$$

Identical relationships can be written for the directions Y and Z. The dimensions of the sintered part can be physically measured on the final part 30 (before finishing, if applicable). Consequently, the values ΔXₛᵢₙₜ^{crosslink} and ΔXₛᵢₙₜ^{GAD} can also be obtained by calculation from the measured values.

By combining the above equations, in the direction X, the following relations (which only involve values accessible by measurement) are obtained:

$$\frac{Δ {X}_{sint}^{crosslink}}{{X}_{crosslink}} = ( \frac{Δ {X}_{sint}^{necks}}{{X}_{necks}} + 1 ) \cdot ( \frac{Δ {X}_{necks}^{crosslink}}{{X}_{crosslink}} + 1 ) - 1 = ( \frac{{X}_{sint}}{{X}_{necks}} ) \cdot ( \frac{{X}_{necks}}{{X}_{crosslink}} ) - 1$$

$$\frac{Δ {X}_{sint}^{CAD}}{{X}_{CAD}} = ( \frac{Δ {X}_{sint}^{necks}}{{X}_{necks}} + 1 ) \cdot ( \frac{Δ {X}_{necks}^{crosslink}}{{X}_{crosslink}} + 1 ) \cdot ( \frac{Δ {X}_{crosslink}^{CAD}}{{X}_{CAD}} + 1 ) - 1 = ( \frac{{X}_{sint}}{{X}_{necks}} ) \cdot ( \frac{{X}_{necks}}{{X}_{crosslink}} ) \cdot ( \frac{{X}_{crosslink}}{{X}_{CAD}} ) - 1$$

Depending on the objective pursued, this relationship can be rewritten in different ways. For example, if the objective is to determine the deformations and dimensional changes step by step, it is possible to reintroduce the dimensions of the printed part; it is recalled, however, that unlike the dimensions of the CAD, crosslinked, pre-sintered and sintered part which can be measured, the dimensions of the printed part are only estimated:

$$\frac{Δ {X}_{sint}^{CAD}}{{X}_{CAD}} = ( \frac{{X}_{sint}}{{X}_{necks}} ) \cdot ( \frac{{X}_{necks}}{{X}_{crosslink}} ) \cdot ( \frac{{X}_{crosslink}}{{X}_{print}} ) \cdot ( \frac{{X}_{print}}{{X}_{CAD}} ) - 1$$

Conversely, if the objective is rather to counter-deform the CAD part so as to obtain a sintered part directly to the desired dimensions, then the relationship is written more simply:

$$\frac{Δ {X}_{sint}^{CAD}}{{X}_{CAD}} = ( \frac{{X}_{sint}}{{X}_{CAD}} ) - 1$$

Of course, any intermediate level between the most developed and the most concise writing can be used. Knowing these dimensions, it is possible to better size the CAD file governing the printing, for all the desired powders and binders, in order to directly obtain a final sintered part with the right dimensions.

Moreover, the relationship giving the dimension Xₚᵣᵢₙₜ involves the number of drops of binder projected in the direction X, N_{g,X}. The device 40 for counting the theoretically projected binder drops therefore allows to access knowledge of the dimensions of the printed part, or even, on this basis, to estimate the saturation of the part in binder, in particular because this saturation governs the mechanical resistance of the green part 24. Saturation is defined as the ratio between the volume of printed binder and the volume of pores partially or totally infiltrated by this binder. Since the binder printing is carried out layer by layer, interest is given to the saturation at the scale of a layer.

The elementary reference surface SER is the product dX.dY, and the elementary reference volume VER is the product dX.dY.dZ. The elementary reference surface represents a surface unit occupied by a drop. However, the elementary reference surface SER thus defined assumes that two adjacent drops are exactly tangent, with no space therebetween or overlap, which does not necessarily correspond to reality, especially if a very low saturation (little binder) or a very high saturation (a lot of binder) is sought.

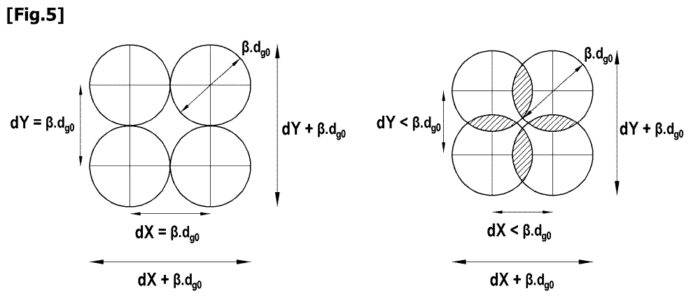

In this perspective, the inventors have developed a four-drop model illustrated in FIG. 5. In this model, it is assumed that four drops are printed, the respective centers of which occupy the vertices of a rectangle of length dx in the direction X and width dY in the direction Y. In order to know the actual surface occupied by the drops on the powder bed, it is necessary to take into account a positive spreading coefficient β, such that the actual surface occupied by the four drops is inscribed in a rectangle of length dX+β.d_{g0} in the direction X and width dY+β.d_{g0} in the direction Y, where d_{g0} is the diameter of the drop in flight.

The spreading coefficient β can be determined experimentally, for example by image analysis recorded with a high-speed camera. According to one possible operating mode, a drop created with a syringe is deposited on a powder bed. The interaction between the drop and the powder bed is fully filmed with a high-speed camera (image acquisition frequency of the order of 2 kHz) in order to see each of the steps: impact of the drop on the powder bed, wetting of the powder by the drop, spreading of the drop and infiltration of the drop into the powder bed. The spreading coefficient β is then obtained by comparing the spreading diameter of the drop at a time t and the diameter of the drop in flight (that is to say the diameter of the drop before infiltration without spreading).

Based on the elementary reference surface, the corrected saturation S_{corr} of the layer may be approximated by the following relationship, involving the number of drops Ng measured by the counting device 40:

$${S}_{corr} = \frac{{V}_{g} \cdot Ng}{{X}_{print} \cdot {Y}_{print} \cdot {dZ}_{print} \cdot Pt}$$

where Pt is the porosity of the powder bed on which the binder is printed (therefore after possible passage of the spreading means 34 and/or compaction means), which may be measured experimentally by techniques known per se to the person skilled in the art. More precisely, Pt is the porosity of the printed volume Vₚᵣᵢₙₜ=Xₚᵣᵢₙₜ. Yₚᵣᵢₙₜ.dZₚᵣᵢₙₜ (ignoring the binder). According to one example, the porosity of the powder bed may be between 40 and 55%.

Here again, it is noted that the calculation of the corrected saturation involves the number of projected binder drops, N_{g}. The counting device 40 for the theoretically or, better, actually projected binder drops therefore allows to approximate the true saturation. The calculation unit 64 is therefore configured to calculate the binder saturation of the powder bed based on the number of drops counted, or even, where appropriate, the number of drops whose passage is detected. Knowing this corrected saturation, it is possible to adjust the print head 18 according to this corrected saturation, in particular to adjust the distances dX and dY between two drops (via the number of passes Np and the activation frequency f, for example), to obtain the desired corrected saturation. This results in a better quality of the part produced.

The controller 60 may have the hardware architecture of a computer. It may in particular include a processor, a read-only memory, a random access memory, a non-volatile memory and means for communication with the rest of the installation 10, in particular the print head 18, the counting device 40 and/or the nozzle cleaner 50, allowing the controller 60 to send or receive signals to these elements.

Although the present description refers to specific exemplary embodiments, modifications may be made to these examples without departing from the general scope of the present disclosure as defined by the claims. For example, although the various components of the installation 10 have been described as capable of moving in certain directions promoting the compactness of the installation 10, other directions of movement are possible for all or part of these components, as long as they remain capable of fulfilling their respective functions. Furthermore, individual features of the various embodiments illustrated or mentioned may be combined in additional embodiments. Consequently, the description and the drawings should be considered in an illustrative rather than restrictive sense.

1. An indirect additive manufacturing installation for indirect additive manufacturing by projection of binder onto a powder bed, comprising a support, a powder supplier configured to form successive powder beds on the support, a print head configured to selectively project the binder onto each of the successive powder beds, and a drop meter for counting drops of the binder projected by the print head onto the powder beds, the drop meter comprising an optical detector configured to optically detect the passage of the drops between the print head and the powder bed.

2. The indirect additive manufacturing installation according to claim 1, wherein the drop meter is configured to determine the positioning of the drops of the binder projected by the print head onto the powder beds.

3. The indirect additive manufacturing installation according to claim 1, wherein the drop meter is configured to take as input an activation signal of the print head.

4. The indirect additive manufacturing installation according to claim 1, wherein the drop meter is configured to correct a count carried out from an activation signal of the print head on the basis of the optical detection of the passage of the drops.

5. The indirect additive manufacturing installation according to claim 1, wherein the optical detector comprises at least one of a laser sheet, a scanner and a set of diodes.

6. The indirect additive manufacturing installation according to claim 1, further comprising a nozzle cleaner configured to clean at least one nozzle of the print head based on a clogging signal emitted by the drop meter.

7. The indirect additive manufacturing installation according to claim 1, comprising a unit for evaluating the dimensions of a part printed by binder projection based on a number of the drops counted.

8. The indirect additive manufacturing installation according to claim 1, comprising a unit for calculating a binder saturation of the powder bed based on a number of the drops counted and optionally a drop spreading coefficient.

9. A method for indirect additive manufacturing by projecting binder onto a powder bed, comprising forming successive powder beds on a support, selectively projecting binder onto each of the powder beds, the method further comprising counting the projected drops of the binder, the counting comprising optically detecting the passage of the drops between the print head and the powder bed.

10. The indirect additive manufacturing method according to claim 9, wherein the selectively projecting the binder is carried out by a print head, and comprising adjusting the print head according to a binder saturation of the powder bed calculated based on a number of drops counted.
